(19) United States
(12) Patent Application Publication
(10) Pub. No.: US 2013/0312660 A1
(43) Pub. Date: Nov. 28, 2013

(54) ARTICLE CARRIER

(71) Applicants: Chih-Lin Yang, New Taipei City (TW); Li-Nien Hsu, New Taipei City (TW)

(72) Inventors: Chih-Lin Yang, New Taipei City (TW); Li-Nien Hsu, New Taipei City (TW)

(73) Assignee: Cheng Uei Precision Industry Co., LTD., New Taipei City (TW)

(21) Appl. No.: 13/478,062

(22) Filed: May 22, 2012

(51) Int. Cl. B05C 13/00

(52) U.S. Cl. 118/500

(57) ABSTRACT

An article carrier adapted for holding and carrying a plurality of articles includes a carrier band, and a plurality of carrier racks connected with the carrier band by means of connecting plates. Each article defines an inserting groove. Each carrier rack has a first buckling arm extending forward from the connecting plate. An elastic arm of substantially lying-V shape from a lateral view is connected with a front edge of the first buckling arm with the mouth thereof facing rearward. A rear edge of the elastic arm extends rearward to form a second buckling arm. Each carrier rack is inserted into the inserting groove under the guidance of the elastic arm, and the first and second buckling arms resist against a top inner sidewall and a bottom inner sidewall of the inserting groove by virtue of an elastic force of the elastic arm.

### BACKGROUND OF THE INVENTION

1. Field of the Invention

The present invention generally relates to an article carrier, and more particularly to an article carrier capable of holding and carrying a plurality of articles for assisting the articles to be plated one after another.

2. The Related Art

In general, stamped metal parts are connected by an article carrier, so the stamped metal parts can be plated one after another. Nevertheless, with fast development of electronic industry, electronic products are developed towards a complex and precise trend. Accordingly, the metal parts used in the electronic products have complex and precise structure. The metal parts with the complex and precise structure are usually manufactured by CNC (Computer Numerical Control) technology or MIM (Metal Injection Molding) technology.

However, the metal parts manufactured by CNC technology or MIM technology are mostly single spare parts without being carried by any article carrier that fails to realize a continuous plating process. Therefore, it brings inconvenience to a mass production of plating the metal parts and increases a manufacture cost.

### SUMMARY OF THE INVENTION

An object of the present invention is to provide an article carrier adapted for holding and carrying a plurality of articles so as to assist the articles to be plated one after another. Each article defines an inserting groove penetrating through a rear thereof. The article carrier includes a carrier band and a plurality of carrier racks connected with a front edge of the carrier band by means of connecting plates and arranged at regular intervals along the carrier band. Each carrier rack has a first buckling arm extending forward from a front edge of the connecting plate. An elastic arm of substantially lying-V shape from a lateral view is connected with a front edge of the first buckling arm with the mouth thereof facing rearward. A rear edge of the elastic arm extends rearward to form a second buckling arm spaced from and parallel to the first buckling arm. Each carrier rack is inserted into the inserting groove of the article under the guidance of the elastic arm, and the first buckling arm and the second buckling arm resist against a top inner sidewall and a bottom inner sidewall of the inserting groove by virtue of an elastic force of the elastic arm.

As described above, each carrier rack of the article carrier is inserted into the inserting groove of the article under the guidance of the elastic arm, and the first buckling arm and the second buckling arm resist against the top inner sidewall and the bottom inner sidewall of the inserting groove by virtue of the elastic force of the elastic arm. Thus, the articles are held to the carrier racks of the article carrier to be carried by the carrier band of the article carrier so as to ensure the articles realize a continuous plating process. As a result, it brings convenience to a mass production of plating the articles and decreases a manufacture cost.

### BRIEF DESCRIPTION OF THE DRAWINGS

The present invention will be apparent to those skilled in the art by reading the following description, with reference to the attached drawings, in which:

FIG. 1 is a perspective view of an article carrier in accordance with an embodiment of the present invention;

FIG. 2 is another perspective view of the article carrier of FIG. 1;

FIG. 3 is a perspective view of the article carrier of FIG. 1, wherein articles are held to the article carrier or apart away from the article carrier;

FIG. 4 is a perspective view of the article of FIG. 3;

FIG. 5 is a side sectional view of the article carrier with the articles held thereto taken in direction of the arrows and along the plane of line V-V in FIG. 3; and

FIG. 6 is a vertical sectional view of the article carrier with the articles held thereto taken in direction of the arrows and along the plane of line VI-VI in FIG. 3.

### DETAILED DESCRIPTION OF THE PREFERRED EMBODIMENT

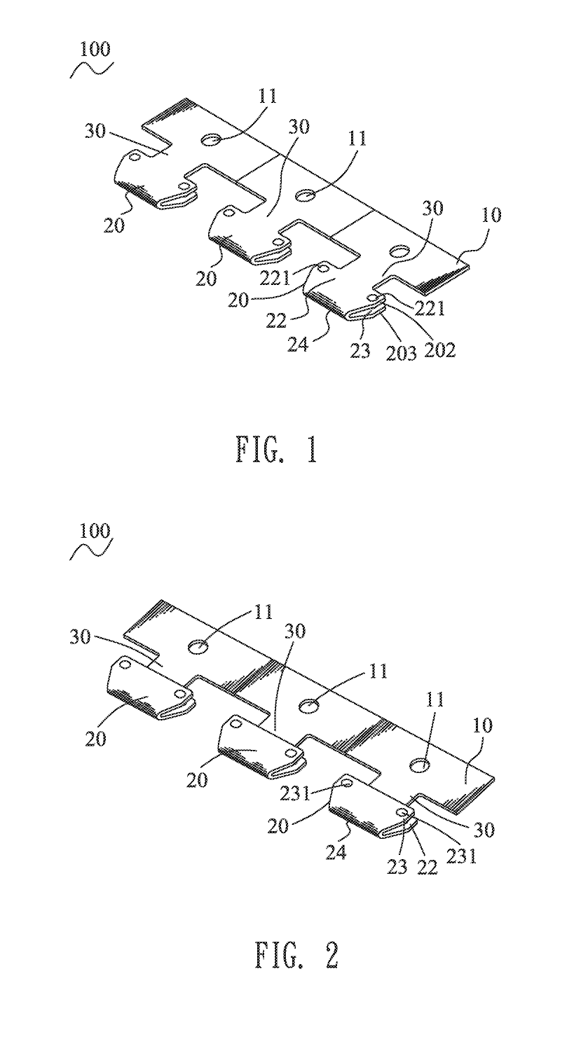

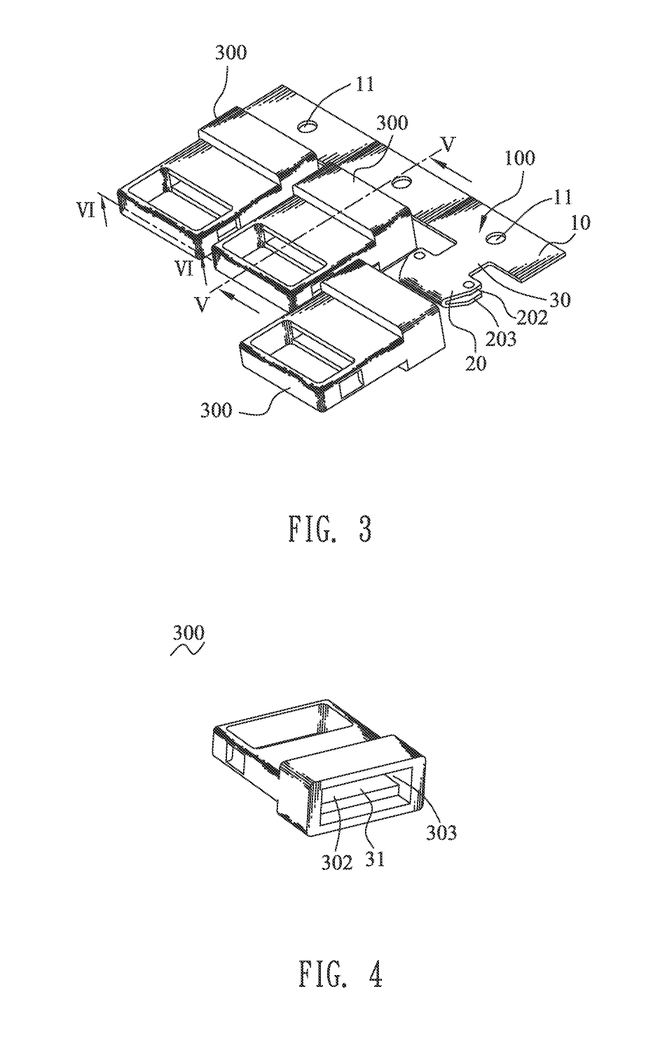

With reference to FIG. 1, FIG. 2 and FIG. 3, an article carrier 100 in accordance with an embodiment of the present invention is shown. The article carrier 100 is adapted for holding and carrying a plurality of articles 300 so as to assist the articles 300 to be plated one after another. The article carrier 100 of a bandoleer shape includes a rectangular plate-shaped carrier band 10, a plurality of rectangular connecting plates 30 connected with a front edge of the carrier band 10 along a transverse direction and arranged at regular intervals, and a plurality of carrier racks 20 connected with the front edge of the carrier band 10 by means of the connecting plates 30 and arranged at regular intervals along the carrier band 10.

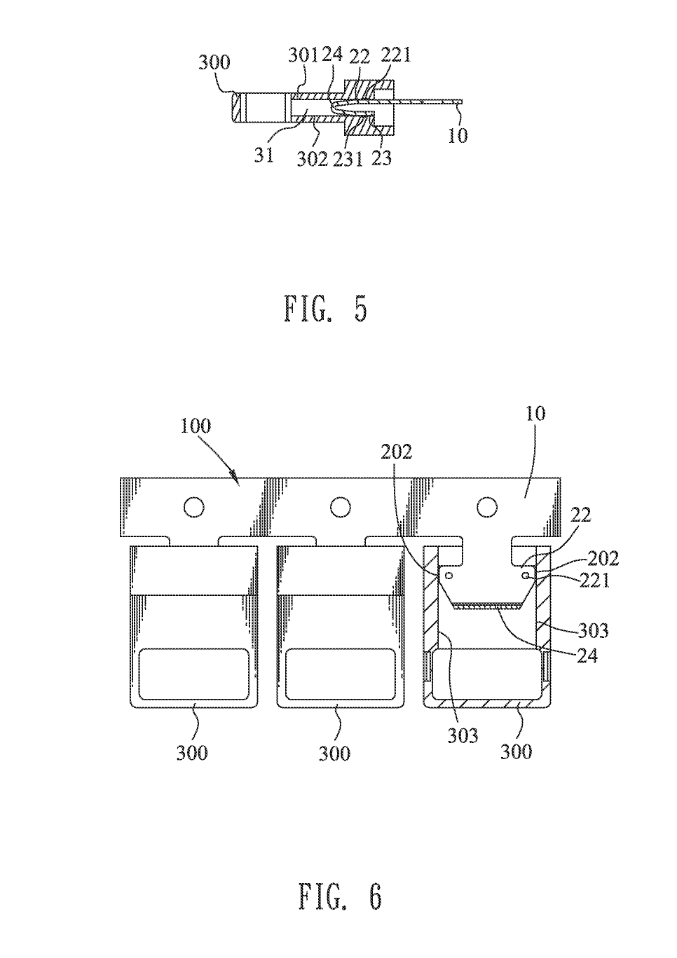

Referring to FIG. 1, FIG. 2 and FIG. 5, a rear edge of the connecting plate 30 is connected with the front edge of the carrier band 10. Each of the carrier racks 20 has a rectangular first buckling arm 22 spreading outward and then extending forward from a front edge of the connecting plate 30. An elastic arm 24 of substantially lying-V shape from a lateral view is connected with a front edge of the first buckling arm 22 with the mouth thereof facing rearward. The bend of the elastic arm 24 shows an arc shape. A rear edge of the elastic arm 24 extends rearward to form a rectangular second buckling arm 23 spaced from and parallel to the first buckling arm 22. The first buckling arm 22 has two vertical first end surfaces 202 parallel to each other, and the second buckling arm 23 has two vertical second end surfaces 203 parallel to each other. The first buckling arm 22 and the second buckling arm 23 have a same length, so each first end surface 202 of the first buckling arm 22 is in alignment with one of the second end surfaces 203 of the second buckling arm 23. Two opposite ends of the first buckling arm 22 protrude upward to form two first protrusions 221. Two opposite ends of the second buckling arm 23 protrude downward to form two second protrusions 231. Each corner of the carrier rack 20 shows the arc shape.

Referring to FIG. 3, FIG. 4, FIG. 5 and FIG. 6, in this embodiment, the articles 300 are metal parts. Each article 300 defines a rectangular inserting groove 31 extending towards a front thereof and penetrating through a middle of a rear thereof. The inserting groove 31 has a top inner sidewall 301 and a bottom inner sidewall 302 parallel to each other, and has two vertical inner sidewalls 303 parallel to each other.

Referring to FIGS. 1-4, when the articles 300 are assembled to the article carrier 100, each of the carrier racks 20 is inserted forward into the inserting groove 31 of the article 300. The carrier band 10 is provided with a plurality of holes 11 corresponding to the carrier racks 20 respectively so that a quantity of the articles 300 carried by the article carrier 100 is known by virtue of counting the holes 11 of the carrier band 10.

Referring to FIGS. 1-6, each carrier rack 20 is inserted into the inserting groove 31 of the article 300 under the guidance of the elastic arm 24, and the top inner sidewall 301 and the bottom inner sidewall 302 of the inserting groove 31 can press against the first protrusions 221 of the first buckling arm 22 and the second protrusions 231 of the second buckling arm 23 to make the first buckling arm 22 elastically approach towards the second buckling arm 23 by virtue of an elastic force of the elastic arm 24 so as to facilitate the article 300 being assembled to the article carrier 100. In addition, vertical degree of freedom of the article 300 is limited by virtue of the elastic force of the elastic arm 24 to make the first buckling arm 22 and the second buckling arm 23 resist against the top inner sidewall 301 and the bottom inner sidewall 302 of the inserting groove 31. The first protrusions 221 of the first buckling arm 22 interferes with the top inner sidewall 301 of the inserting groove 31 of the article 300 and the second protrusions 231 of the second buckling arm 23 interferes with the bottom inner sidewall 302 of the inserting groove 31 of the article 300 for effectively preventing the article 300 slipping off from the carrier rack 20 of the article carrier 100.

Referring to FIGS. 1-6 again, the two first end surfaces 202 of the first buckling arm 22 and the two second end surfaces 203 of the second buckling arm 23 are parallel to and hundred-percent interfere with the two vertical and parallel inner sidewalls 303 of the inserting groove 31 so as to limit transverse degree of freedom of the article 300 for effectively preventing the article 300 slipping off from the carrier rack 20. Each corner of the carrier rack 20 shows the arc shape for contacting with the article 300 smoothly for preventing the carrier rack 20 scratching the inner surfaces of the article 300 in the process of the carrier rack 20 being inserted into the inserting groove 31 of the article 300. Lastly, the articles 300 are held to the carrier racks 20 of the article carrier 100 to be carried by the carrier band 10 of the article carrier 100 so as to ensure the articles 300 realize a continuous plating technology so as to meet a mass production request of plating the articles 300.

As described above, each carrier rack 20 of the article carrier 100 is inserted into the inserting groove 31 of the article 300 under the guidance of the elastic arm 24, and the first buckling arm 22 and the second buckling arm 23 resist against the top inner sidewall 301 and the bottom inner sidewall 302 of the inserting groove 31 by virtue of the elastic force of the elastic arm 24. Thus, the articles 300 are held to the carrier racks 20 of the article carrier 100 to be carried by the carrier band 10 of the article carrier 100 so as to ensure the articles 300 realize the continuous plating process. As a result, it brings convenience to the mass production of plating the articles 300 and decreases a manufacture cost.

What is claimed is:

1. An article carrier adapted for holding and carrying a plurality of articles so as to assist the articles to be plated one after another, each article defining an inserting groove penetrating through a rear thereof, the article carrier comprising:
a carrier band; and
a plurality of carrier racks connected with a front edge of the carrier band by means of connecting plates and arranged at regular intervals along the carrier band, each carrier rack having a first buckling arm extending forward from a front edge of the connecting plate, an elastic arm of substantially lying-V shape from a lateral view being connected with a front edge of the first buckling arm with the mouth thereof facing rearward, a rear edge of the elastic arm extending rearward to form a second buckling arm spaced from and parallel to the first buckling arm;
wherein each carrier rack is inserted into the inserting groove of the article under the guidance of the elastic arm, and the first buckling arm and the second buckling arm resist against a top inner sidewall and a bottom inner sidewall of the inserting groove by virtue of an elastic force of the elastic arm.

2. The article carrier as claimed in claim 1, wherein the bend of the elastic arm shows an arc shape.

3. The article carrier as claimed in claim 1, wherein the first buckling arm has two vertical first end surfaces parallel to each other, and the second buckling arm has two vertical second end surfaces parallel to each other, each first end surface of the first buckling arm is vertically in alignment with one of the two second end surfaces of the second buckling arm, the inserting groove has two vertical and parallel inner sidewalls, the first end surfaces of the first buckling arm and the second end surfaces of the second buckling arm hundred-percent interfere with the two inner sidewalls of the inserting groove.

4. The article carrier as claimed in claim 1, wherein two opposite ends of the first buckling arm protrude upward to form two first protrusions interfering with the top inner sidewall of the inserting groove of the article, and two opposite ends of the second buckling arm protrude downward to form two second protrusions interfering with the bottom inner sidewall of the inserting groove of the article.

5. The article carrier as claimed in claim 1, wherein each corner of the carrier rack shows an arc shape for contacting with the article smoothly.

6. The article carrier as claimed in claim 1, wherein the carrier band is provided with a plurality of holes corresponding to the carrier racks respectively so that a quantity of the articles carried by the article carrier is known by virtue of counting the holes of the carrier band.
